(19) United States
(12) Patent Application Publication
(10) Pub. No.: US 2014/0041111 A1
(43) Pub. Date: Feb. 13, 2014

(54) Modular Sauna Structure and the Method of Producing and Packing the Same

(71) Applicants: Xingjun Qiao, Shenzhen (CN); Pei Qiao, Shenzhen (CN)

(72) Inventors: Xingjun Qiao, Shenzhen (CN); Pei Qiao, Shenzhen (CN)

(21) Appl. No.: 13/813,146

(22) PCT Filed: Apr. 29, 2011
(86) PCT No.: PCT/CN2011/073577

§ 371 Date: Jan. 29, 2013

(51) Int. Cl. A61H 33/06; E04H 1/12

(52) U.S. Cl. CPC A61H 33/06; E04H 1/12
USPC 4/524; 29/428

(57) ABSTRACT

A sauna structure includes several vertical plates, a bottom plate, a top plate and an inner support, and is characterized in that: the vertical plates include two sets with one set as upper vertical plates and one set as lower vertical plates, a connection structure is configured at the lower end of the upper vertical plates, a connection structure is correspondingly configured at the upper end of the lower vertical plates, the bottom plate is mounted at the bottom of the lower vertical plates, the top plate is installed on the top of the upper vertical plates and the inner support is arranged in the area defined by the vertical plates. The vertical plates include two sets of the same height, which leads to the fact that the height of the vertical plates according to the present invention is half of that of vertical plates for a traditional sauna.

### BACKGROUND OF THE PRESENT INVENTION

1. Field of Invention

The present invention relates to the technical field of saunas, and more especially, to a modular sauna structure and the method of producing and packing the same.

2. Description of Related Arts

According to the study of medical experts, 500 cc of sweat from a person is equivalent to the exercise of jogging for 10 km, while the calories consumed by 1 cc of sweat are as high as 700 kcal of heat. It will be very helpful for people who lack exercise, are fat, weak in resistance, apt to catch a cold, have backaches and are weary, in particular, for the elderly prone to having rheumatism and twinges of arthritis, and women tending to have cold hands and feet in winter, to make use of a sauna to stimulate the flow of blood, allow hot air to flow upwards from the feet, and ease hidden pain by relying on perspiration, so as to become more healthy and more energetic. However, the sauna in the prior art is often in large size, increasing the difficulties and costs in transportation.

### SUMMARY OF THE PRESENT INVENTION

The present invention aims at providing a method for producing a modular sauna featuring small volume and easy transportation by overcoming the disadvantages above.

Another objective of the present invention is to provide a modular sauna structure featuring small volume and easy transportation.

Another objective of the present invention is to provide a method for packing the modular sauna featuring varied packing patterns, convenient transportation, reduced freight, and costs.

To realize the objectives above, the present invention adopts the following technical solutions:

A modular sauna structure, comprising several vertical plates, a bottom plate, a top plate, and an inner support, wherein the vertical plates include two sets with one set as an upper vertical plate assembly and one set as a lower vertical plate assembly, a connection means is configured at the lower end of the upper vertical plate assembly, a connection means is correspondingly configured at the upper end of the lower vertical plate assembly, the bottom plate is mounted at the bottom of the lower vertical plate assembly, the top plate is installed on the top of the upper vertical plate assembly and the inner support is arranged in the area defined by the vertical plates.

Preferably, the connection means at the lower end of the upper vertical plates is a tenon bar/mortise slot, and the connection means at the upper end of the lower vertical plates is the corresponding mortise slot/tenon bar.

Preferably, the upper vertical plate assembly includes an upper back panel, an upper front panel and an upper left-right panel, wherein the two sides of the upper back panel are connected with one side of the left-right panel, the two sides of the upper front panel are connected with the other side of the left-right panel; the lower vertical plate assembly is provided with a lower back panel, a lower front panel and a lower left-right panel correspondingly.

The modular sauna structure further comprises a handle which is arranged on the vertical plates.

Preferably, the handle is arranged on the upper front panel and the lower front panel.

The modular sauna structure further comprises two installation bars, wherein two installation holes are respectively provided on the upper and lower parts of the handle, two installation holes are respectively provided on the upper and lower vertical plates, the first installation bar is inserted into the installation hole of the upper vertical plate and the installation hole of the upper part of the handle; the second installation bar is inserted into the installation hole of the lower vertical plate and the installation hole of the lower part of the handle.

The modular sauna structure further comprises a fixing plate, wherein an installation hole is provided at the position of the fixing plate corresponding to the installation hole of the handle, the fixing plate is arranged inside the upper and lower vertical plates, and the installation bars pass through the installation holes on the fixing plate, the upper and lower vertical plates, and the handle in sequence.

The modular sauna structure further comprises a hook which is arranged on the fixing plate.

A method for producing the modular sauna structure above comprises the following steps of:

1) blanking, and preparing the vertical plates, the bottom plate, the top plate, and the inner support;

2) dividing the vertical plates into two sets with one set as the upper vertical plate assembly and one set as the lower vertical plate assembly, wherein the height of the upper vertical plate assembly is identical to that of the lower vertical plate assembly;

3) configuring a connection means at the lower end of the upper vertical plate assembly, and correspondingly configuring a connection means at the upper end of the lower vertical plate assembly;

4) fittingly connecting the connection means at the lower end of the upper vertical plate assembly with the connection means at the upper end of the lower vertical plate assembly;

5) arranging the bottom plate at the bottom of the lower vertical plate assembly;

6) arranging the top plate on the top of the upper vertical plate assembly; and

7) arranging the inner support in the area defined by the vertical plates.

In the method for producing the modular sauna structure above, the modular sauna structure further comprises a handle, and the method further comprises a following step of:

8) installing the handle on the upper and lower vertical plate assemblies.

A method for packing the modular sauna structure above comprises the following steps of:

a) packing the upper left-right panel of the upper vertical plate assembly and the lower left-right panel of the lower vertical plate assembly into a packaging case;

b) packing the upper front panel of the upper vertical plate assembly, the lower front panel of the lower vertical plate assembly, the top plate, and the bottom plate into a packaging case; and

c) packing the upper back panel of the upper vertical plate assembly, the lower back panel of the lower vertical plate assembly, the inner support and the handle into a packaging case.

The steps a), b), and c) can be exchanged discretionarily.

With the technical solution above, the vertical plates include two sets of the same height, which leads to the fact that the height of the vertical plates according to the present invention is half of that of vertical plates for a traditional sauna. Therefore, during packing, the maximum dimensions of each packaging case is certainly smaller than those for a traditional one, thus conducive to better utilizing space in transportation and placing more products under the same situation, further saving space, reducing freight and costs.

### BRIEF DESCRIPTION OF THE DRAWINGS

FIG. 1 is a schematic view of the structure of Embodiment 1 for the present invention;

FIG. 2 is a partially sectional view of the upper and lower vertical plates of the sauna structure according to the present invention;

FIG. 3 is a schematic view of the packaging when a traditional way is replaced by the present invention;

FIG. 4 is a schematic view of the structure of Embodiment 2 for the present invention;

FIG. 5 is a partially sectional view of Embodiment 2 for the present invention;

FIG. 6 is a schematic view of the interior of Embodiment 3 for the present invention;

FIG. 7 shows A sectional views of FIG. 6;

FIG. 8 is the front view of FIG. 7;

FIG. 9 shows B sectional views of FIG. 6;

FIG. 10 is the front view of FIG. 9

### DETAILED DESCRIPTION OF THE PREFERRED EMBODIMENT

To further understand the objectives, technical solution, and advantages of the present invention, the present invention is further detailed in combination with the figures and the embodiments. It shall be understood that the embodiments described herein are only to illustrate the present invention, rather than limit it.

### Embodiment 1

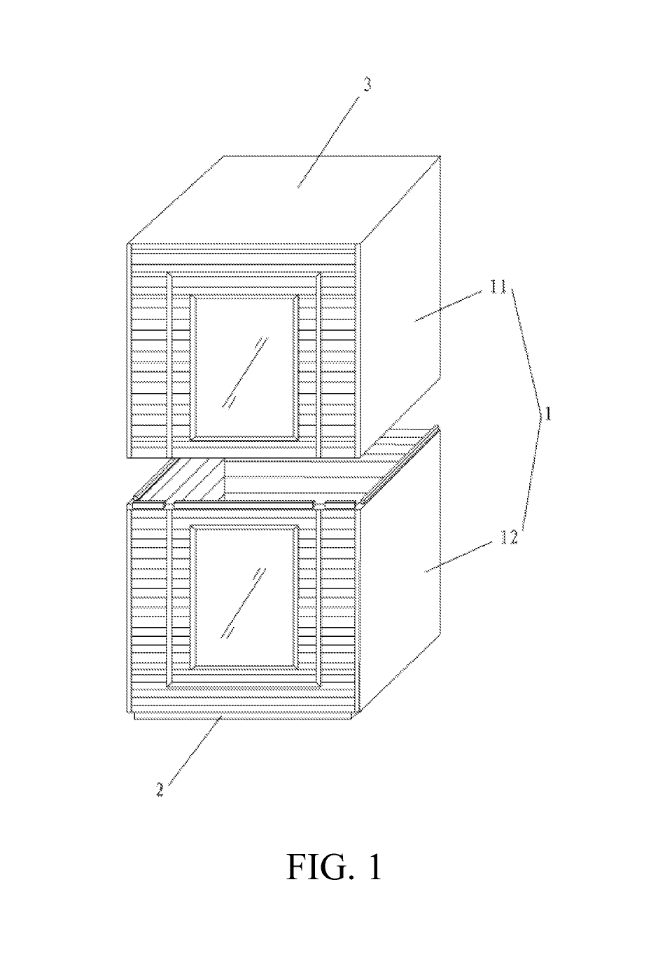

As shown in FIG. 1, the present invention discloses a modular sauna structure, comprising several vertical plates 1, a bottom plate 2, a top plate 3 and an inner support (not shown), wherein:

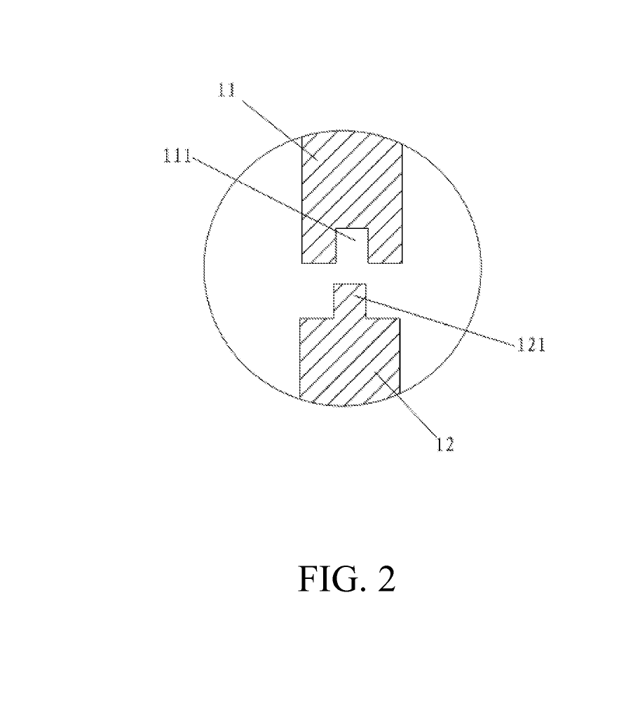

the vertical plates 1 include two sets with one set as an upper vertical plate assembly 11 and one set as a lower vertical plate assembly 12, a connection means is configured at the lower end of the upper vertical plate assembly 11, as shown in FIG. 2, in this embodiment, the connection means is a mortise slot 111; a connection means is correspondingly configured at the upper end of the lower vertical plate assembly 12, in this embodiment, the connection means is a tenon bar 121; the bottom plate 2 is mounted at the bottom of the lower vertical plate assembly 12, the top plate 3 is installed on the top of the upper vertical plate assembly 11 and the inner support is arranged in the area defined by the vertical plates 1.

The method for producing the modular sauna structure above comprises the following steps of:

1) blanking, and preparing the vertical plates 1, the bottom plate 2, the top plate 3 and the inner support;

2) dividing the vertical plates 1 into two sets with one set as an upper vertical plate assembly 11 and one set as a lower vertical plate assembly 12, wherein the height of the upper vertical plate assembly 11 is identical to that of the lower vertical plate assembly 12; and the height of the upper and lower vertical plate assemblies is almost half of that of the vertical plates for a traditional sauna.

3) configuring a connection means at the lower end of the upper vertical plate assembly 11, and correspondingly configuring a connection means at the upper end of the lower vertical plate assembly 12;

4) fittingly connecting the connection means at the lower end of the upper vertical plate assembly 11 with the connection means at the upper end of the lower vertical plate assembly 12;

5) arranging the bottom plate 2 at the bottom of the lower vertical plate assembly 12;

6) arranging the top plate 3 on the top of the upper vertical plate assembly 11; and

7) arranging the inner support in the area defined by the vertical plates 1.

When realizing Embodiment 1, the vertical plates include two sets of the same height, which leads to the fact that the height of the vertical plates according to the present invention is half of that of vertical plates for a traditional sauna. Therefore, during packing, the maximum dimensions of each packaging case is certainly smaller than those for a traditional one, thus conducive to better utilizing space in transportation and placing more products under the same situation.

### Embodiment 2

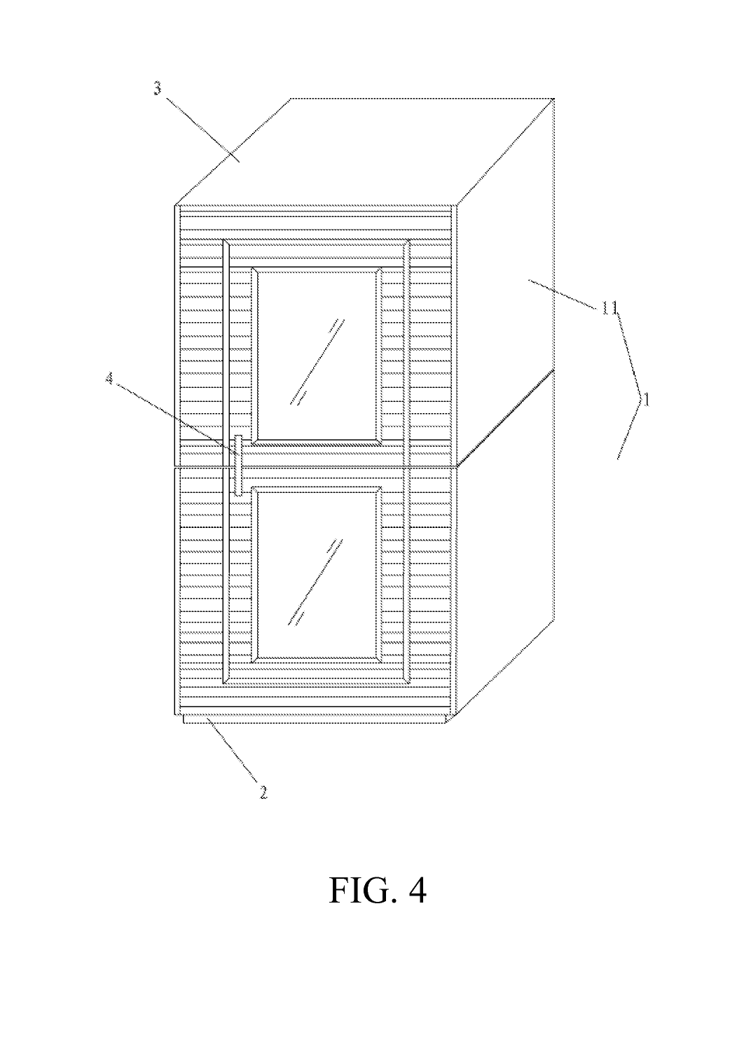

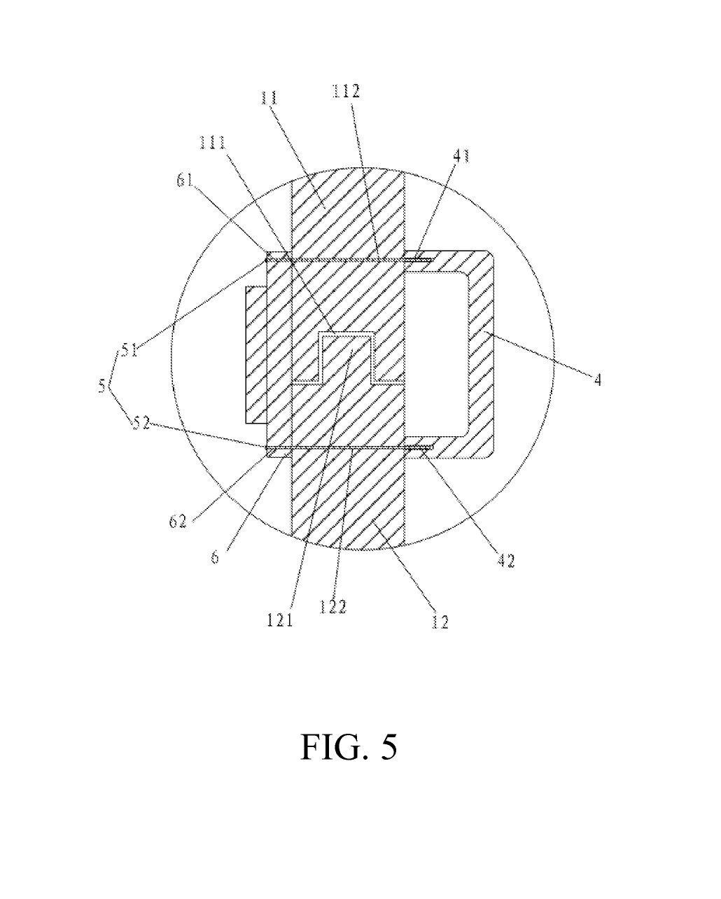

As shown in FIG. 4, compared with Embodiment 1, the differences lie in that: it further comprises a handle 4, an installation bar 5, and a fixing plate 6. In this embodiment, as shown in FIG. 5, there are two installation bars 5, namely 51 and 52 respectively. Two installation holes 41, 42 are respectively provided on the upper and lower parts of the handle 4, two installation holes 112, 122 are respectively provided on the upper and lower vertical plates 11, 12, two installation holes 61, 62 are also respectively provided on the fixing plate 6 corresponding to the installation holes 41, 42 of the handle 4, the fixing plate 6 is arranged inside the upper and lower vertical plates 11, 12, and the installation bars 51, 52 pass through the installation holes 61, 62 on the fixing plate 6, the installation holes 112, 122 of the upper and lower vertical plates 11, 12 and the installation holes 41, 42 of the handle 4 in sequence.

In this way, the handle 4 is installed on the vertical plates 1, and allows the upper vertical plate 11 and the lower vertical plate 12 to be opened so that the upper and lower parts realize synchronous opening and closing.

During packing, the handle 4, the installation bars 5, and the fixing plate 6 can be packed separately, or packed together with the bottom plate 2 and the top plate 3 in a packaging case.

### Embodiment 3

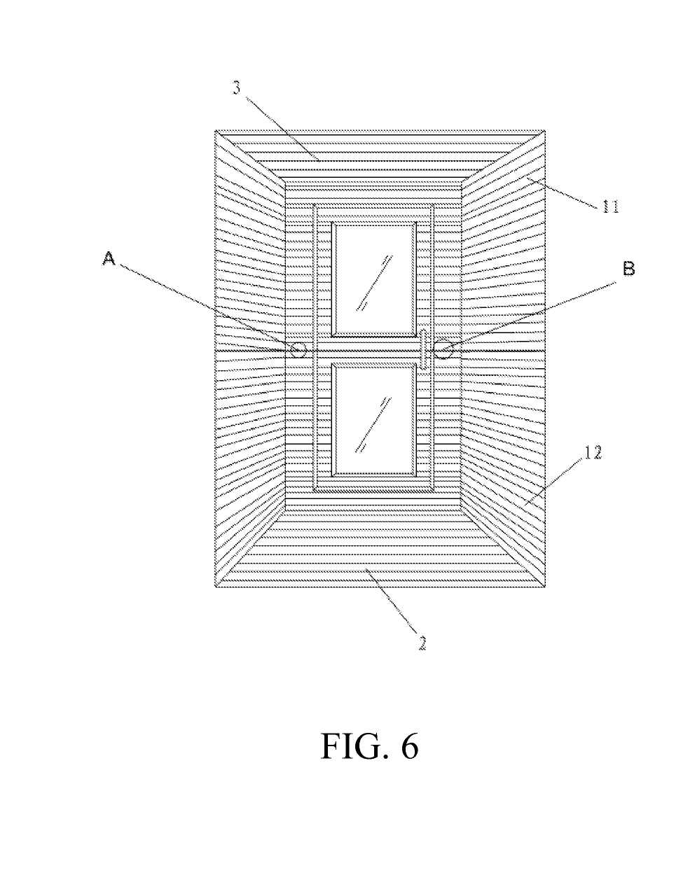

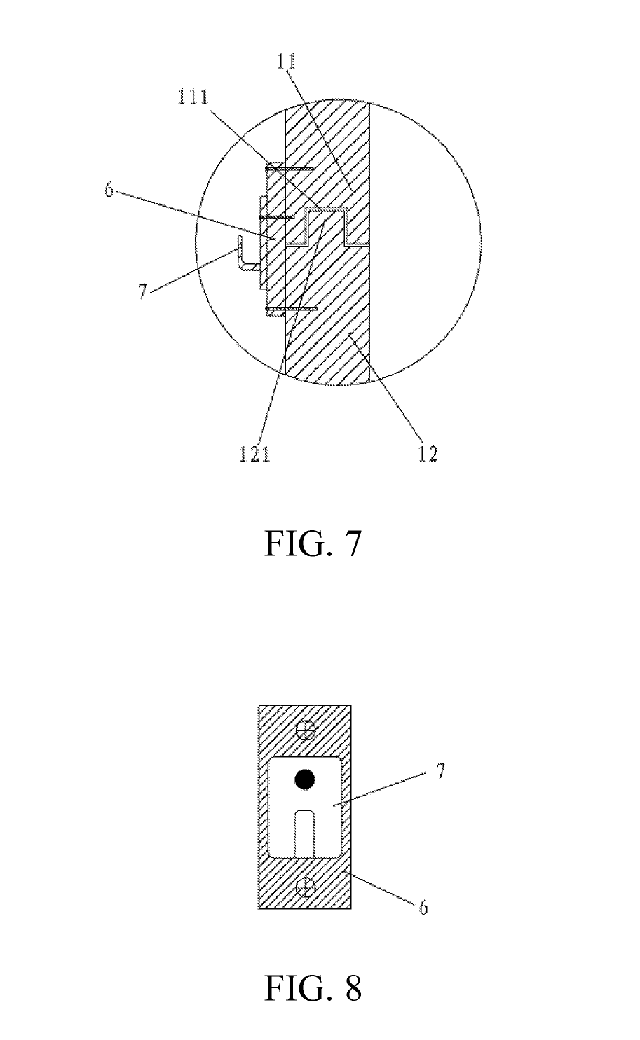

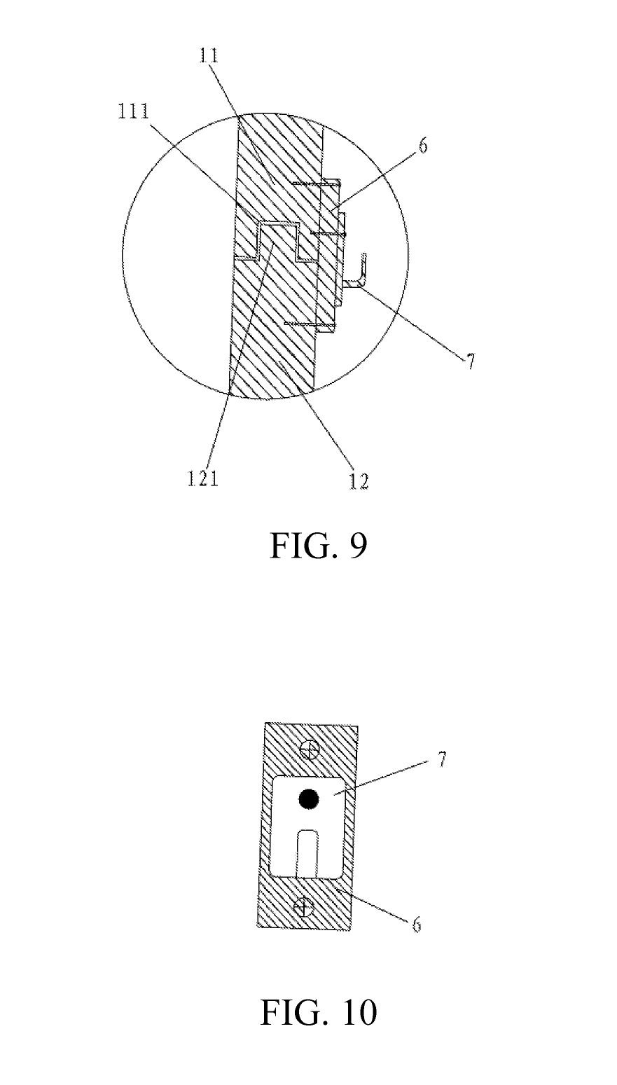

As shown in FIGS. 6-10, compared with Embodiment 2, the differences lie in that: it further comprises a hook 7 which is fixed onto the fixing plate 6.

Additionally, the upper vertical plate assembly 11 includes an upper back panel, an upper front panel and an upper left-right panel, wherein the two sides of the upper back panel are connected with one side of the left-right panel, the two sides of the upper front panel are connected with the other side of the left-right panel; the lower vertical plate assembly 12 is provided with a lower back panel, a lower front panel and a lower left-right panel correspondingly.

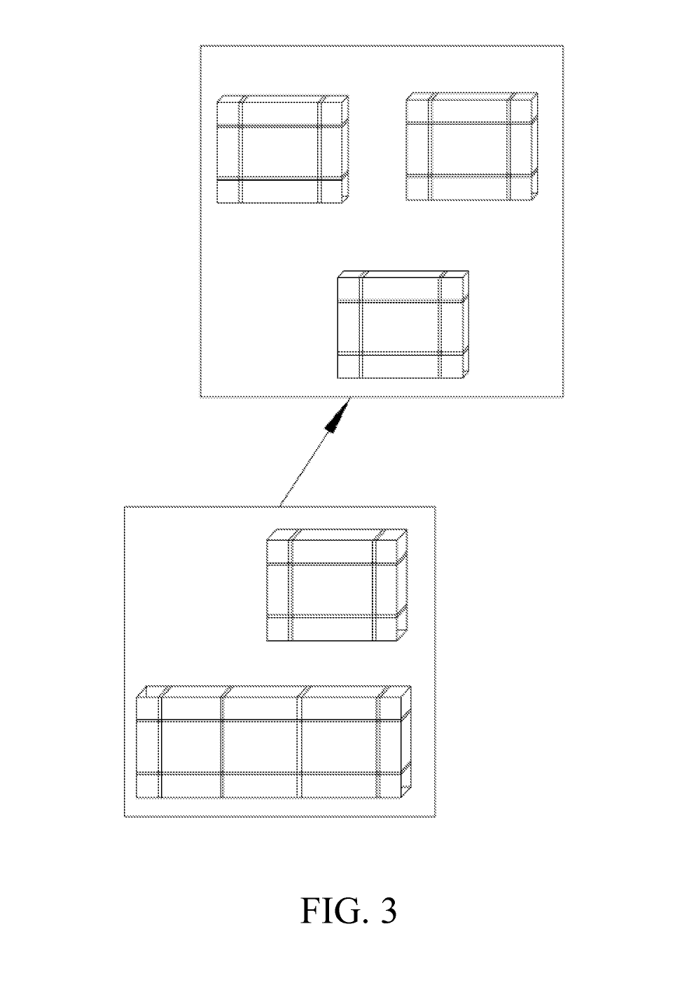

As shown in FIG. 3, the packing method of the modular sauna for transportation mainly comprises the following steps of:

a) packing the upper left-right panel of the upper vertical plate assembly 11 and the lower left-right panel of the lower vertical plate assembly 12 into a packaging case;

b) packing the upper front panel of the upper vertical plate assembly, the lower front panel of the lower vertical plate assembly, the top plate and the bottom plate into a packaging case; and

c) packing the upper back panel of the upper vertical plate assembly, the lower back panel of the lower vertical plate assembly, the inner support and the handle into a packaging case.

The steps a), b), and c) can be exchanged discretionarily.

Since the upper and lower vertical plates 11, 12 are of the same height, in this embodiment, the upper and lower vertical plates 11, 12 on the right of the present invention are 950 mm high and 1070 mm wide, while the vertical plates for a traditional structure as shown in FIG. 3 on the left are 1850 mm high and 1070 mm wide. When packing them, the maximum dimension of the packaging case is 1070 mm for the present invention, while that for the packing of a traditional sauna is 1850 mm. Therefore, when packing them into a packaging case, the maximum height dimension is certainly smaller than that for a traditional one.

With the same height and width of the bottom plate 2 and the top plate 3, so in this embodiment, they can be packed in one packaging case together with the inner support. Furthermore, the inner support can be also separately packed.

With this packing mode, when transporting the structure by means of containers, about ⅓ space can be saved under the same situation. Additionally, when volume and weight are as the criteria for freight calculation, this structure can be conducive to reducing freight and costs.

Above description is only to illustrate the preferred embodiments but not to limit the protection scope of the present invention. Any change, equivalent substitution or improvement made by the person skilled in this art within the technical scope disclosed in the present invention should be covered in the protection scope of the present invention. Therefore, the protection scope of the present invention shall be subject to that of the claims.

1-11. (canceled)

12. A modular sauna structure, comprising several vertical plates, a bottom plate, a top plate and an inner support, wherein the vertical plates include two sets with one set as an upper vertical plate assembly and one set as a lower vertical plate assembly, a connection means is configured at a lower end of the upper vertical plate assembly, a connection means is correspondingly configured at an upper end of the lower vertical plate assembly, the bottom plate is mounted at a bottom of the lower vertical plate assembly, the top plate is installed on a top of the upper vertical plate assembly and the inner support is arranged in an area defined by the vertical plates.

13. The modular sauna structure, as recited in claim 12, wherein the connection means at the lower end of the upper vertical plates is a tenon bar/mortise slot, and the connection means at the upper end of the lower vertical plates is the corresponding mortise slot/tenon bar.

14. The modular sauna structure, as recited in claim 12, wherein the upper vertical plate assembly includes an upper back panel, an upper front panel and an upper left-right panel, wherein two sides of the upper back panel are connected with one side of the left-right panel, two sides of the upper front panel are connected with the other side of the left-right panel; and the lower vertical plate assembly is provided with a lower back panel, a lower front panel and a lower left-right panel correspondingly.

15. The modular sauna structure, as recited in claim 13, wherein the upper vertical plate assembly includes an upper back panel, an upper front panel and an upper left-right panel, wherein two sides of the upper back panel are connected with one side of the left-right panel, two sides of the upper front panel are connected with the other side of the left-right panel; and the lower vertical plate assembly is provided with a lower back panel, a lower front panel and a lower left-right panel correspondingly.

16. The modular sauna structure, as recited in claim 14, further comprising a handle which is arranged on the vertical plates.

17. The modular sauna structure, as recited in claim 15, further comprising a handle which is arranged on the vertical plates.

18. The modular sauna structure, as recited in claim 16, wherein the handle is arranged on the upper front panel and the lower front panel.

19. The modular sauna structure, as recited in claim 17, wherein the handle is arranged on the upper front panel and the lower front panel.

20. The modular sauna structure, as recited in claim 18, further comprising two installation bars, wherein two installation holes are respectively provided on upper and lower parts of the handle, two installation holes are respectively provided on the upper and lower vertical plates, the first installation bar is inserted into the installation hole of the upper vertical plate and the installation hole of the upper part of the handle; and the second installation bar is inserted into the installation hole of the lower vertical plate and the installation hole of the lower part of the handle.

21. The modular sauna structure, as recited in claim 19, further comprising two installation bars, wherein two installation holes are respectively provided on upper and lower parts of the handle, two installation holes are respectively provided on the upper and lower vertical plates, the first installation bar is inserted into the installation hole of the upper vertical plate and the installation hole of the upper part of the handle; and the second installation bar is inserted into the installation hole of the lower vertical plate and the installation hole of the lower part of the handle.

22. The modular sauna structure, as recited in claim 20, further comprising a fixing plate, wherein two installation holes are respectively provided at positions of the fixing plate corresponding to the two installation holes of the handle, the fixing plate is arranged inside the upper and lower vertical plates, and the installation bars pass through the installation holes on the fixing plate, the upper and lower vertical plates and the handle in sequence.

23. The modular sauna structure, as recited in claim 21, further comprising a fixing plate, wherein two installation holes are respectively provided at positions of the fixing plate corresponding to the two installation holes of the handle, the fixing plate is arranged inside the upper and lower vertical plates, and the installation bars pass through the installation holes on the fixing plate, the upper and lower vertical plates and the handle in sequence.

24. The modular sauna structure, as recited in claim 22, further comprising a hook which is arranged on the fixing plate.

25. The modular sauna structure, as recited in claim 23, further comprising a hook which is arranged on the fixing plate.

26. A method for producing a modular sauna structure, comprising steps of:
1) blanking, and preparing several vertical plates, a bottom plate, a top plate and an inner support;
2) dividing the vertical plates into two sets with one set as an upper vertical plate assembly and one set as a lower vertical plate assembly, wherein a height of the upper vertical plate assembly and the lower vertical plate assembly is the same;
3) configuring a connection means at a lower end of the upper vertical plate assembly, and correspondingly configuring a connection means at an upper end of the lower vertical plate assembly;
4) fittingly connecting the connection means at the lower end of the upper vertical plate assembly with the connection means at the upper end of the lower vertical plate assembly;
5) arranging the bottom plate at a bottom of the lower vertical plate assembly;
6) arranging the top plate on a top of the upper vertical plate assembly; and
7) arranging the inner support in an area defined by the vertical plates.

27. The method, as recited in claim 26, further comprising a step of installing a handle on the upper and lower vertical plate assemblies.

28. The method, as recited in claim 27, wherein the upper vertical plate assembly includes an upper back panel, an upper front panel and an upper left-right panel, wherein two sides of the upper back panel are connected with one side of the left-right panel, two sides of the upper front panel are connected with the other side of the left-right panel; and the lower vertical plate assembly is provided with a lower back panel, a lower front panel and a lower left-right panel correspondingly.

29. The method, as recited in claim 28, wherein the handle is arranged on the upper front panel and the lower front panel.

30. The method, as recited in claim 29, wherein the connection means at the lower end of the upper vertical plates is a tenon bar/mortise slot, and the connection means at the upper end of the lower vertical plates is the corresponding mortise slot/tenon bar.

31. A method for packing a modular sauna structure comprising several vertical plates, a bottom plate, a top plate and an inner support, wherein the vertical plates include two sets with one set as an upper vertical plate assembly and one set as a lower vertical plate assembly, a connection means is configured at a lower end of the upper vertical plate assembly, a connection means is correspondingly configured at an upper end of the lower vertical plate assembly, the bottom plate is mounted at a bottom of the lower vertical plate assembly, the top plate is installed on a top of the upper vertical plate assembly and the inner support is arranged in an area defined by the vertical plates, the upper vertical plate assembly includes an upper back panel, an upper front panel and an upper left-right panel, wherein two sides of the upper back panel are connected with one side of the left-right panel, two sides of the upper front panel are connected with the other side of the left-right panel; and the lower vertical plate assembly is provided with a lower back panel, a lower front panel and a lower left-right panel correspondingly,
wherein the method comprises steps of:
1) packing the upper left-right panel of the upper vertical plate assembly and the lower left-right panel of the lower vertical plate assembly into a packaging case;
2) packing the upper front panel of the upper vertical plate assembly, the lower front panel of the lower vertical plate assembly, the top plate and the bottom plate into a packaging case; and
3) packing the upper back panel of the upper vertical plate assembly, the lower back panel of the lower vertical plate assembly, the inner support and the handle into a packaging case.
